(19) United States
(12) Patent Application Publication
(10) Pub. No.: US 2026/0241378 A1
(43) Pub. Date: Aug. 20, 2026

(54) METHOD FOR SEPARATING AND REGENERATING ANION EXCHANGE RESIN AND CATION EXCHANGE RESIN OF MIXED ION EXCHANGE RESIN

(71) Applicant: KURITA WATER INDUSTRIES LTD., Tokyo (JP)

(72) Inventors: Yuuichi OGAWA, Tokyo (JP); Midori MIYAJI, Tokyo (JP)

(73) Assignee: KURITA WATER INDUSTRIES LTD., Tokyo (JP)

(21) Appl. No.: 19/110,435

(22) PCT Filed: Sep. 15, 2023
(86) PCT No.: PCT/JP2023/033719

§ 371 Date: Mar. 11, 2025

(30) Foreign Application Priority Data
Oct. 6, 2022 (JP) 2022-161567

(51) Int. Cl. B01J 49/57; B01J 47/04; B01J 49/53; B01J 49/60

(52) U.S. Cl. CPC B01J 49/57; B01J 47/04; B01J 49/53; B01J 49/60

(57) ABSTRACT

A method for separating and regenerating anion exchange resin and cation exchange resin of mixed ion exchange resin consists of a three-tower configuration including a separation tower, a cation exchange resin regeneration tower, and a seprex tower. In a separation process in the separation tower, anion exchange resin and cation exchange resin are separated. The separated anion exchange resin is transferred to the seprex tower in which the cation exchange resin mixed therein is separated and removed using a high concentration NaOH aqueous solution with a specific gravity intermediate between a specific gravity of the anion exchange resin and a specific gravity of the cation exchange resin, and is also subjected to regeneration treatment. In addition, the cation exchange resin separated in the separation process in the separation tower is transferred to the cation exchange tower in which an HCl solution is injected to regenerate the cation exchange resin.

### TECHNICAL FIELD

The present invention relates to a method for separating and regenerating anion exchange resin and cation exchange resin used in a non-regenerative ion exchange device and a mixed bed ion exchange device employed in a pure water production device and the like.

### DESCRIPTION OF RELATED ART

In a pure water production device, impurities in raw water are removed to enhance the purity of water, and a mixed bed ion exchange device filled with a mixture of anion exchange resin and cation exchange resin is commonly used to remove ionic impurities, namely anionic impurities and cationic impurities. In the mixed bed ion exchange device, when the ion exchange resin exchanges an amount of ions equivalent to the ion exchange capacity, the ion exchange resin can no longer remove additional ionic impurities, resulting in breakthrough. Therefore, after treating a certain amount of treated water, the ion exchange resin is recovered from the mixed bed ion exchange device, and is regenerated using hydrochloric acid and sodium hydroxide in a cation exchange resin regeneration tower and an anion exchange resin regeneration tower, respectively, for reuse. In this process, the anion exchange resin and the cation exchange resin are generally separated by utilizing the difference in sedimentation rates due to the specific gravity difference between the anion exchange resin and the cation exchange resin, using upward flow water passage.

An example of a separation tower of the mixed ion exchange resin is shown in FIG. 4. In FIG. 4, a separation tower 21 of mixed ion exchange resin has a water inlet/outlet 22 provided at the bottom of a cylindrical separation tower body 21A, along with a water supply pipe 23 serving as a water discharge part provided with multiple discharge nozzles 23A, and a drain 24 formed at the top. A water collection plate 25 is disposed below the discharge nozzles 23A of the separation tower body 21A. Furthermore, anion exchange resin extraction piping 26, serving as an anion exchange resin extraction part, is provided around the middle in an up-down direction inside the separation tower 21, and cation exchange resin extraction piping 27 is provided below the anion exchange resin extraction piping 26 and slightly above the water supply pipe 23. Additionally, a peephole 28 is formed on a side surface of the separation tower 21. It should be noted that 29 is an inlet for a used mixed ion exchange resin provided on the upper side of a side surface of the separation tower 21.

In such a separation tower 21 of mixed ion exchange resin, used mixed ion exchange resin is input into the separation tower 21, followed by passing through an approximately 4 weight % NaOH aqueous solution, and after leaving the tower for a predetermined time, pure water is injected from the water inlet/outlet 22 to extrude the NaOH aqueous solution inside the separation tower from the drain 24, and washing is performed. Then, a predetermined amount of water for separation (pure water) is filled in the separation tower 21. At this time, the water surface of the water for separation is made to be higher than the upper surface of the mixed ion exchange resin, particularly to be about 500 mm or less higher.

Next, air is injected into the separation tower through the water inlet/outlet 24, and the mixed ion exchange resin is bubbled to loosen the resin particles entangled in a colloidal state, after which the bubbling is stopped, and the mixed ion exchange resin is allowed to settle on the water collection plate 25. At this time, the cation exchange resin with a larger specific gravity settles first, and the anion exchange resin with a smaller specific gravity settles later. Subsequently, in preparation for backwashing, pure water (water for separation) is introduced from the water inlet/outlet 22 so that the separation tower 21 is filled with water.

In the full-water state, pure water is discharged from the discharge nozzle 23A and water is passed through in an upward flow, and adjustment is made while visually checking through the peephole 28 so that the separation interface becomes the lower end of the suction port of the anion exchange resin extraction piping 26. Then, the anion exchange resin is sucked through the anion exchange resin extraction piping 26 and taken out as an anion exchange resin-water mixed phase flow. The anion exchange resin-water mixed phase flow, after being dewatered, is transferred to the anion exchange resin regeneration tower for regenerating the anion exchange resin.

After extracting the anion exchange resin in this manner, while continuing to discharge the pure water from the discharge nozzle 23A, the cation exchange resin is sucked through the cation exchange resin extraction piping 27, and is discharged and taken out as a cation exchange resin-water mixed phase flow. The cation exchange resin-water mixed phase flow, after being dewatered, is transferred to the cation exchange resin regeneration tower for regenerating the cation exchange resin. At this time, not all of the cation exchange resin is taken out, but some is left remaining to prevent the mixing of anion exchange resin.

However, as mentioned above, the method for separating anion exchange resin and cation exchange resin had a problem that the separation between the two was insufficient. Especially, while cation exchange resin can be separated well by leaving the interface part inside the separation tower 21, there was a problem that cation exchange resin tends to mix into the anion exchange resin which is extracted first.

Therefore, the seprex method, which uses a high-concentration NaOH aqueous solution to separate anion exchange resin and cation exchange resin, is applied. The seprex method performs the treatment in a process as shown in FIG. 5.

In other words, after extracting the anion exchange resin in the separation process (first separation process) shown in FIG. 5 using the separation tower 21 shown in FIG. 4 as mentioned earlier, the anion exchange resin is transferred to a tower (seprex tower) dedicated to separating the cation exchange resin mixed in the anion exchange resin. In the seprex tower, an NaOH aqueous solution with a specific gravity intermediate between the specific gravity of the anion exchange resin and the specific gravity of the cation exchange resin is injected, and the resin is loosened by bubbling and left to stand, allowing the cation exchange resin that has been mixed in to settle to the lower side, and the cation exchange resin is extracted and removed from the lower part of the seprex tower. Next, pure water is supplied to the tower, and after extrusion and washing of the NaOH aqueous solution, the remaining anion exchange resin is extracted (second separation process). The extracted anion exchange resin is transferred to the anion exchange resin regeneration tower and the anion exchange resin is regenerated and washed by a standard method. On the other hand, the cation exchange resin separated in the first separation process is transferred to the cation exchange resin regeneration tower and the cation exchange resin is regenerated and washed by a standard method.

### SUMMARY

### Technical Problem

As described above, by means of the seprex method, anion exchange resin and cation exchange resin can be separated with extremely low mixing of the other. However, in the seprex method, as shown in FIG. 5, four towers are required: a separation tower, an anion exchange resin regeneration tower, a cation exchange resin regeneration tower, and a seprex tower. This not only increases the initial cost but also increases the number of work processes such as the transfer process of ion exchange resin, which was a problem.

The present invention has been made in view of the above-mentioned problems, and is intended to provide a method for separating and regenerating anion exchange resin and cation exchange resin of mixed ion exchange resin, which enables accurate separation of anion exchange resin and cation exchange resin using the seprex method without increasing the initial cost.

### Solution to the Problem

In view of the above-mentioned purpose, the present invention provides a method for separating and regenerating anion exchange resin and cation exchange resin of mixed ion exchange resin which is a method for separating and regenerating anion exchange resin and cation exchange resin from mixed ion exchange resin of anion exchange resin and cation exchange resin, including: a separation process in which mixed ion exchange resin is input into a separation tower of mixed ion exchange resin of a substantially cylindrical shape that includes an input part for mixed ion exchange resin, an anion exchange resin extraction part provided midway in an up-down direction, a cation exchange resin extraction part provided below the anion exchange resin extraction part, and an injection part for air and water for separation provided at a bottom, water for separation is passed upward from the injection part for air and water for separation into the separation tower, and the mixed ion exchange resin is separated utilizing specific gravity difference; a transfer process in which the anion exchange resin above a separation interface between the anion exchange resin and cation exchange resin is extracted from the anion exchange resin extraction part and transferred to an anion exchange resin separation and regeneration tower, while remaining cation exchange resin is extracted from the cation exchange resin extraction part and transferred to a cation exchange resin regeneration tower; an anion exchange resin separation and regeneration process in which the anion exchange resin is immersed in a NaOH aqueous solution of 5 weight % or more and 30 weight % or less in the anion exchange resin separation and regeneration tower to separate cation exchange resin mixed in the anion exchange resin, the cation exchange resin is discharged and the anion exchange resin is regenerated; an anion exchange resin washing process in which the anion exchange resin remaining in the anion exchange resin separation and regeneration tower is washed with water; a cation exchange resin regeneration process in which the cation exchange resin in the cation exchange resin regeneration tower is regenerated in the cation exchange resin regeneration tower; and a cation exchange resin washing process in which the cation exchange resin remaining in the cation exchange resin regeneration tower is washed with water (Invention 1).

According to the invention (Invention 1), cation exchange resin mixed in anion exchange resin separated in the separation tower is input into the anion exchange resin separation and regeneration tower, and the NaOH aqueous solution with a specific gravity intermediate between a specific gravity of the anion exchange resin and a specific gravity of the cation exchange resin is injected, and the specific gravity difference is utilized to separate the cation exchange resin mixed in the anion exchange resin while the anion exchange resin is regenerated. By doing so, the functions of two towers-a seprex tower solely for separating cation exchange resin and an anion exchange resin regeneration tower-can be performed in one tower, enabling a three-tower configuration instead of the conventional four-tower configuration of the seprex tower. This allows for accurate separation of anion exchange resin and cation exchange resin using the seprex method without increasing the initial cost.

In the above invention (Invention 1), it is preferable that the anion exchange resin and the cation exchange resin are porous type ion exchange resin (Invention 2).

According to the invention (Invention 2), since the specific gravity of the NaOH aqueous solution of 5 weight % or more and 30 weight % or less can be between both the specific gravity of porous type anion exchange resin and the specific gravity of porous type ion exchange resin, the cation exchange resin mixed in the anion exchange resin can be suitably separated by utilizing the specific gravity difference.

### Effects

According to the method for separating and regenerating anion exchange resin and cation exchange resin of mixed ion exchange resin of the present invention, in the anion exchange resin separation and regeneration tower, a NaOH aqueous solution with a specific gravity intermediate between a specific gravity of anion exchange resin and a specific gravity of cation exchange resin is injected into the anion exchange resin, which is prone to mixing with cation exchange resin. By utilizing the specific gravity difference, the cation exchange resin mixed in the anion exchange resin is separated while the anion exchange resin is regenerated. As a result, anion exchange resin and cation exchange resin may be separated with high accuracy without increasing the initial cost with a three-tower configuration.

### BRIEF DESCRIPTION OF THE DRAWINGS

FIG. 1 is a process diagram showing a method for separating and regenerating anion exchange resin and cation exchange resin of mixed ion exchange resin according to a first embodiment of the present invention.

FIG. 2 is a process diagram showing a method for separating and regenerating anion exchange resin and cation exchange resin of mixed ion exchange resin according to a second embodiment of the present invention.

FIG. 3 is a process diagram showing the method for separating and regenerating anion exchange resin and cation exchange resin of mixed ion exchange resin in Comparative Example 1.

FIG. 4 is a schematic diagram showing an example of a separation tower for anion exchange resin and cation exchange resin of mixed ion exchange resin.

FIG. 5 is a process diagram showing the method for separating and regenerating anion exchange resin and cation exchange resin of mixed ion exchange resin using the conventional seprex method.

### DESCRIPTION OF EMBODIMENTS

The following is a detailed description of a method for separating and regenerating anion exchange resin and cation exchange resin of mixed ion exchange resin of the present invention, with reference to the accompanying drawings.

### First Embodiment

### [Mixed Ion Exchange Resin Separation and Regeneration System Configuration]

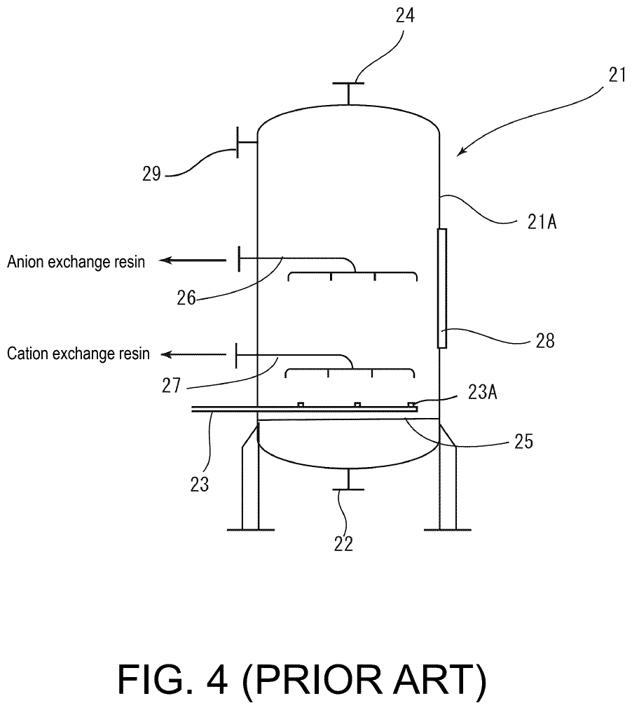

The method for separating and regenerating anion exchange resin and cation exchange resin of mixed ion exchange resin of the present invention consists of, for example, a three-tower configuration including a separation tower as shown in FIG. 4 mentioned above, a cation exchange resin regeneration tower, and a seprex tower (anion exchange resin separation and regeneration tower).

### (Mixed Ion Exchange Resin)

In the embodiment, the mixed ion exchange resin is mixed resin of anion exchange resin and cation exchange resin. The ratio (volume ratio) of the anion exchange resin and the cation exchange resin in the mixed ion exchange resin is not particularly limited, but is about anion exchange resin: cation exchange resin=30:70 to 70:30.

The anion exchange resin and the cation exchange resin are both preferably porous type ion exchange resin. The porous type anion exchange resin, for example, has a specific gravity (when wet) of about 1.03 to 1.09 g/mL, and the porous type cation exchange resin, for example, has a specific gravity (when wet) of about 1.22 to 1.30 g/mL.

### [Method for Separating and Regenerating Anion Exchange Resin and Cation Exchange Resin of Mixed Ion Exchange Resin]

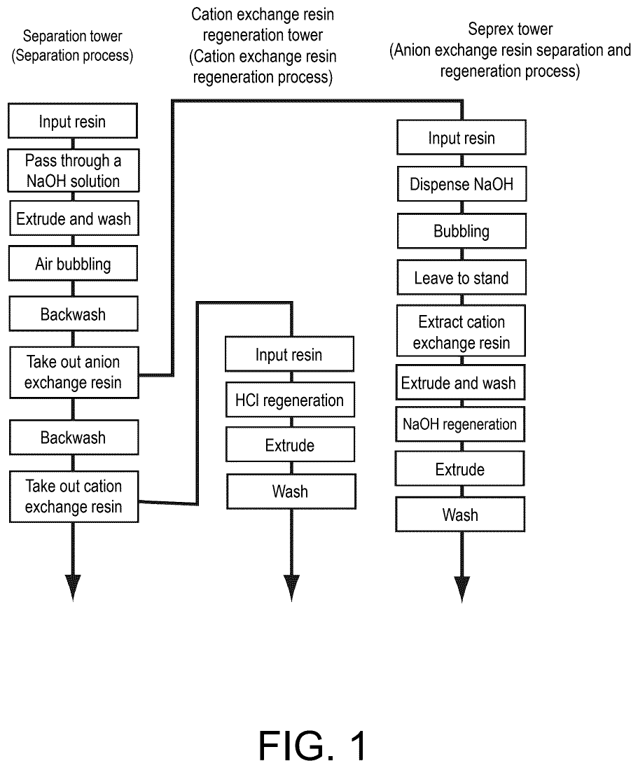

Next, the method for separating and regenerating mixed ion exchange resin of the embodiment using the device configuration having the aforementioned structure will be described based on the flow chart of FIG. 1.

### (Separation Process)

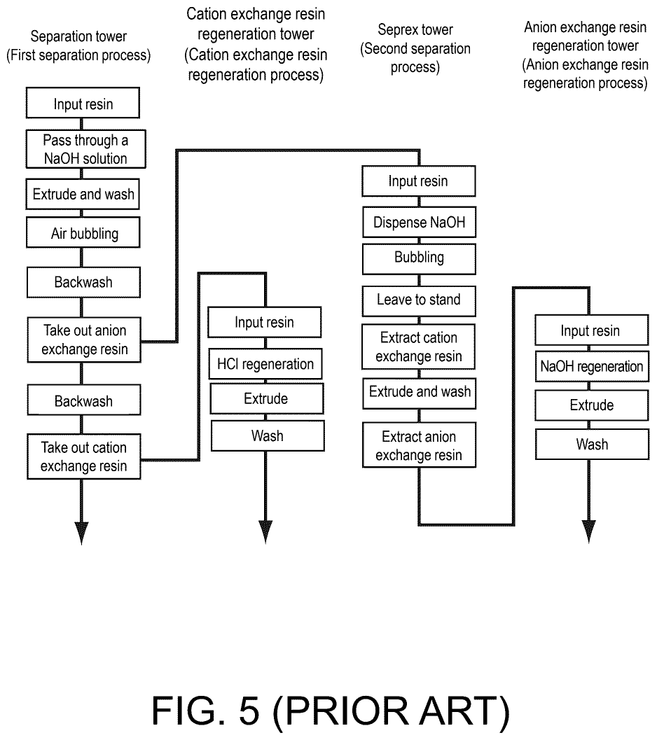

As the separation process is the same as the separation process shown in FIG. 5 described earlier, a detailed description thereof is omitted.

### (Anion Exchange Resin Separation and Regeneration Process)

The anion exchange resin taken out in the separation process is mixed in with a small amount of cation exchange resin. Therefore, the following operations are performed in the seprex tower.

First, after inputting the anion exchange resin into the seprex tower, a NaOH aqueous solution is dispensed. The NaOH aqueous solution is set to have a specific gravity intermediate between a specific gravity of the anion exchange resin and a specific gravity of the cation exchange resin at a concentration of 5 to 30 weight %. For example, when the anion exchange resin and the cation exchange resin are of the porous type, the NaOH aqueous solution has a concentration of 9 to 25 weight %. The NaOH aqueous solution possesses a specific gravity of about 1.10 to 1.27 g/mL.

Next, air is injected into the seprex tower through the water inlet/outlet, and after the anion exchange resin is bubbled for a predetermined time, the bubbling is stopped and the anion exchange resin is allowed to settle by leaving the anion exchange resin to stand. In the settling, as the NaOH aqueous solution is set to have a specific gravity intermediate between the specific gravity of the anion exchange resin and the specific gravity of the cation exchange resin, merely the cation exchange resin with a larger specific gravity settles.

In this state, the cation exchange resin is sucked through the cation exchange resin extraction piping provided at the bottom of the seprex tower, and is discharged and extracted as a cation exchange resin-water mixed phase flow and extracted. The cation exchange resin-water mixed phase flow, after being dewatered, may be input together during the next separation and regeneration of mixed ion exchange resin.

Subsequently, pure water is supplied to the seprex tower to extrude and discharge the NaOH aqueous solution in the tower while washing the anion exchange resin. Then, after discharging the pure water from the seprex tower, a NaOH aqueous solution (concentration of about 4 weight % or so) is passed through again to regenerate the anion exchange resin, followed by supplying pure water to the seprex tower to extrude and discharge the NaOH aqueous solution in the tower while washing the anion exchange resin. In this way, the anion exchange resin can be regenerated. The regenerated anion exchange resin can be taken out from the tower and reused.

### (Cation Exchange Resin Regeneration Process)

In the cation exchange resin regeneration tower, operations are performed in the same manner as the conventional method. First, after inputting the cation exchange resin into the cation exchange resin regeneration tower, an HCl solution as an inorganic acid is injected to regenerate the cation exchange resin.

Subsequently, pure water is supplied to the cation exchange resin regeneration tower to extrude and discharge the HCl solution in the tower, while washing the cation exchange resin. In this way, the cation exchange resin can be regenerated. The regenerated cation exchange resin can be taken out from the cation exchange resin regeneration tower and reused.

In the above-mentioned embodiment, in the seprex tower, the separation of cation exchange resin mixed in the anion exchange resin and the regeneration of the anion exchange resin are performed, so the separation and regeneration of anion exchange resin and cation exchange resin can be carried out in a three-tower configuration system. In addition, as it becomes a three-tower operation, the number of work processes can also be reduced.

### Second Embodiment

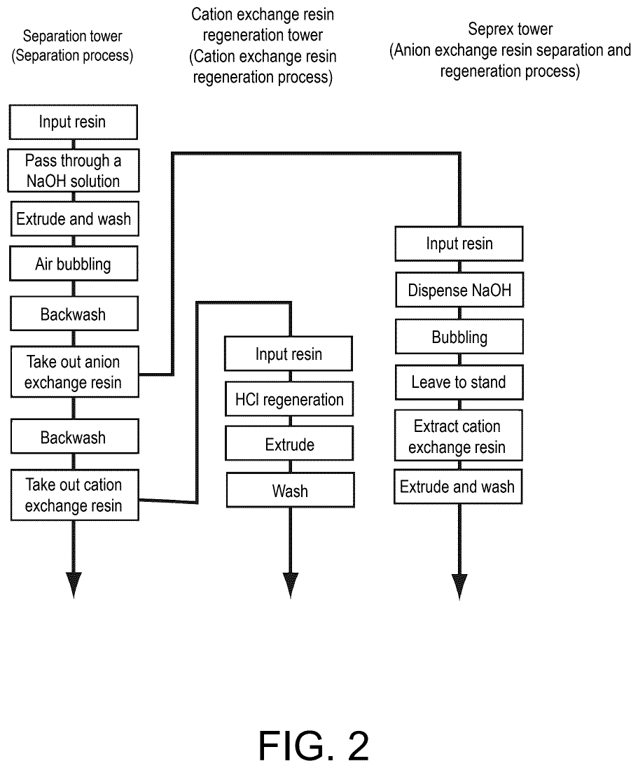

The method for separating and regenerating anion exchange resin and cation exchange resin of the mixed ion exchange resin in the second embodiment is performed according to the flow shown in FIG. 2.

The embodiment, in the aforementioned first embodiment, after completing the process of separating and extracting the cation exchange resin mixed in by immersing the anion exchange resin separated in the first separation process in a high-concentration NaOH aqueous solution, assumes that the subsequent regeneration with a NaOH aqueous solution is completed with the immersion in the high-concentration NaOH aqueous solution, and merely performs extrusion and washing of the NaOH aqueous solution with pure water.

In the embodiment, by performing the separation of the anion exchange resin from the cation exchange resin mixed therein and the regeneration of the anion exchange resin in a single process during the anion exchange resin separation and regeneration process, workability may be further improved compared to the aforementioned first embodiment. Additionally, a reduction in the amount of the NaOH aqueous solution used may be achieved.

The present invention will be described in further detail by the following specific examples.

### EXAMPLE 1

A device was configured with a separation tower of mixed ion exchange resin, a cation exchange resin regeneration tower, and a seprex tower, and the separation, purification, and regeneration of anion exchange resin and cation exchange resin were performed according to the process shown in FIG. 1. As the anion exchange resin, a porous type anion exchange resin with a specific gravity of 1.05 g/mL (when wet) was used, and as the cation exchange resin, a porous type cation exchange resin with a specific gravity of 1.28 g/mL (when wet) was used, respectively. As the NaOH aqueous solution for separation in the seprex tower, a 16 weight % NaOH aqueous solution (specific gravity 1.18) was used.

By the separation and purification of Example 1, the mixing rates of both the anion exchange resin and cation exchange resin were able to be separated with extremely high accuracy at 0.005% each. Also, the conversion rate of OH in the anion exchange resin was 99% or higher. And, the initial cost of the device was about 60 million yen.

### EXAMPLE 2

A device was configured with a separation tower of mixed ion exchange resin, a cation exchange resin regeneration tower, and a seprex tower, and the separation, purification, and regeneration of anion exchange resin and cation exchange resin were performed in the same manner as in Example 1, except that the process shown in FIG. 2 was implemented.

By the separation and purification of Example 2, the mixing rates of both the anion exchange resin and cation exchange resin were able to be separated with extremely high accuracy at 0.005% each. Also, the conversion rate of OH in the anion exchange resin was 99% or higher. And, the initial cost of the device was about 60 million yen.

### COMPARATIVE EXAMPLE 1

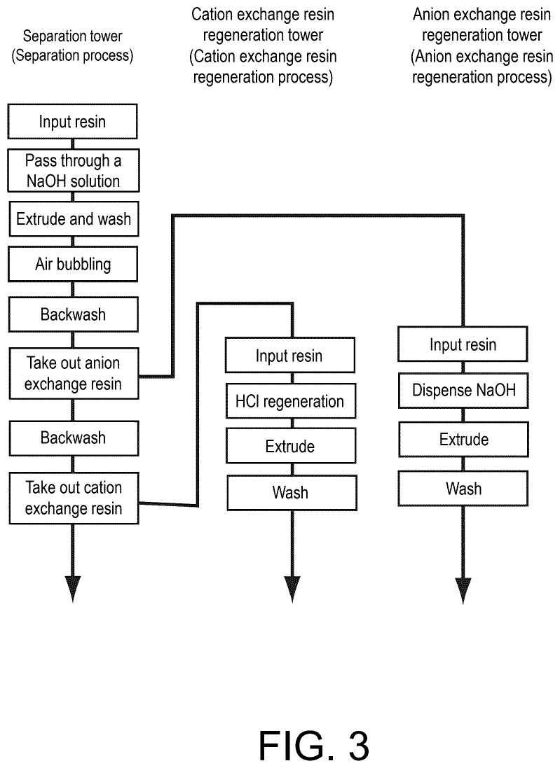

A device was configured with a separation tower of mixed ion exchange resin, a cation exchange resin regeneration tower, and an anion exchange resin regeneration tower. As shown in FIG. 3, a process was implemented to perform separation, purification, and regeneration of anion exchange resin and cation exchange resin by merely carrying out regeneration treatment with a NaOH aqueous solution for regeneration, without performing separation of the cation exchange resin mixed in the anion exchange resin.

By the separation and purification of Comparative Example 1, the mixing rates of both the anion exchange resin and cation exchange resin were 0.02% each, which were higher compared to Example 1 and Example 2, and were unsuitable for applications requiring high-purity regenerated resin. Also, the conversion rate of OH in the anion exchange resin was 99% or higher. And, the initial cost of the device was about 60 million yen.

### COMPARATIVE EXAMPLE 2

A device was configured with a separation tower of mixed ion exchange resin, a cation exchange resin regeneration tower, an anion exchange resin regeneration tower, and a seprex tower, and the process shown in FIG. 5 was implemented to perform separation, purification, and regeneration of anion exchange resin and cation exchange resin.

By the separation and purification of Comparative Example 2, the mixing rates of both the anion exchange resin and cation exchange resin were able to be separated with extremely high accuracy at 0.005% each. Also, the conversion rate of OH in the anion exchange resin was 99% or higher. However, the initial cost of the device was about 80 million yen.

### REFERENCE SIGNS LIST

21 separation tower of mixed ion exchange resin
21A separation tower body
22 water inlet/outlet
23 water supply pipe
23A discharge nozzle
24 drain
25 water collection plate

26 anion exchange resin extraction piping
27 resin extraction piping
28 peephole
29 inlet for used mixed ion exchange resin

1. A method for separating and regenerating anion exchange resin and cation exchange resin of mixed ion exchange resin which is a method for separating and regenerating anion exchange resin and cation exchange resin from mixed ion exchange resin of anion exchange resin and cation exchange resin, the method comprising:
a separation process of inputting mixed ion exchange resin into a separation tower of mixed ion exchange resin of a substantially cylindrical shape that comprises an input part for mixed ion exchange resin, an anion exchange resin extraction part provided midway in an up-down direction, a cation exchange resin extraction part provided below the anion exchange resin extraction part, and an injection part for air and water for separation provided at a bottom, passing water for separation upward from the injection part for air and water for separation into the separation tower, and separating the mixed ion exchange resin utilizing specific gravity difference;
a transfer process of extracting anion exchange resin above a separation interface between the anion exchange resin and cation exchange resin from the anion exchange resin extraction part and transferring the anion exchange resin extracted to an anion exchange resin separation and regeneration tower, while extracting remaining cation exchange resin from the cation exchange resin extraction part and transferring the remaining cation exchange resin to a cation exchange resin regeneration tower;
an anion exchange resin separation and regeneration process of immersing the anion exchange resin in a NaOH aqueous solution of 5 weight % or more and 30 weight % or less in the anion exchange resin separation and regeneration tower to separate cation exchange resin mixed in the anion exchange resin, discharging the cation exchange resin and regenerating the anion exchange resin;
an anion exchange resin washing process of washing the anion exchange resin remaining in the anion exchange resin separation and regeneration tower with water;
a cation exchange resin regeneration process of regenerating the cation exchange resin in the cation exchange resin regeneration tower in the cation exchange resin regeneration tower; and
a cation exchange resin washing process of washing the cation exchange resin remaining in the cation exchange resin regeneration tower with water.

2. The method for separating and regenerating anion exchange resin and cation exchange resin of mixed ion exchange resin according to claim 1, wherein the anion exchange resin and the cation exchange resin are porous type ion exchange resin.
